(19) United States
(12) Patent Application Publication
(10) Pub. No.: US 2019/0193518 A1
(43) Pub. Date: Jun. 27, 2019

(54) Vehicle Safety Assembly

(71) Applicant: Leo Pitre, Larose, LA (US)

(72) Inventor: Leo Pitre, Larose, LA (US)

(21) Appl. No.: 15/851,164

(22) Filed: Dec. 21, 2017

(51) Int. Cl. B60H 1/26; B60H 1/00; B60H 1/24

(52) U.S. Cl. CPC B60H 1/262; B60H 1/00428; B60H 2001/3485; B60H 1/00778; B60H 1/00828; B60H 1/245

(57) ABSTRACT

A vehicle safety assembly for protecting an unattended occupant in a vehicle from excessive temperatures includes a housing that maybe mounted on a roof of a vehicle. A fan is positioned within the housing and the fan urges air when the fan is turned on. The fan ventilates an interior of the vehicle to reduce a temperature of the interior of the vehicle. In this way an unattended occupant from is inhibited from being injured by excessive temperatures in the vehicle. A temperature sensor is positioned within the vehicle and the temperature sensor is in thermal communication with the interior of the vehicle. The temperature sensor is electrically coupled to the fan and the temperature sensor turns the fan on when the temperature sensor senses a trigger temperature.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

### (2) Description of Related Art Including Information Disclosed Under 37 CFR 1.97 and 1.98

The disclosure and prior art relates to safety devices and more particularly pertains to a new safety device for protecting an unattended occupant in a vehicle from excessive temperatures.

### BRIEF SUMMARY OF THE INVENTION

An embodiment of the disclosure meets the needs presented above by generally comprising a housing that maybe mounted on a roof of a vehicle. A fan is positioned within the housing and the fan urges air when the fan is turned on. The fan ventilates an interior of the vehicle to reduce a temperature of the interior of the vehicle. In this way an unattended occupant from is inhibited from being injured by excessive temperatures in the vehicle. A temperature sensor is positioned within the vehicle and the temperature sensor is in thermal communication with the interior of the vehicle. The temperature sensor is electrically coupled to the fan and the temperature sensor turns the fan on when the temperature sensor senses a trigger temperature.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a perspective in-use view of a vehicle safety assembly according to an embodiment of the disclosure.

FIG. 2 is a perspective view of an embodiment of the disclosure.

FIG. 3 is a left side view of an embodiment of the disclosure.

FIG. 4 is a back view of an embodiment of the disclosure.

FIG. 5 is a bottom view of an embodiment of the disclosure.

FIG. 6 is a cross sectional view taken along line 6-6 of FIG. 2 of an embodiment of the disclosure.

FIG. 7 is a schematic view of an embodiment of the disclosure.

### DETAILED DESCRIPTION OF THE INVENTION

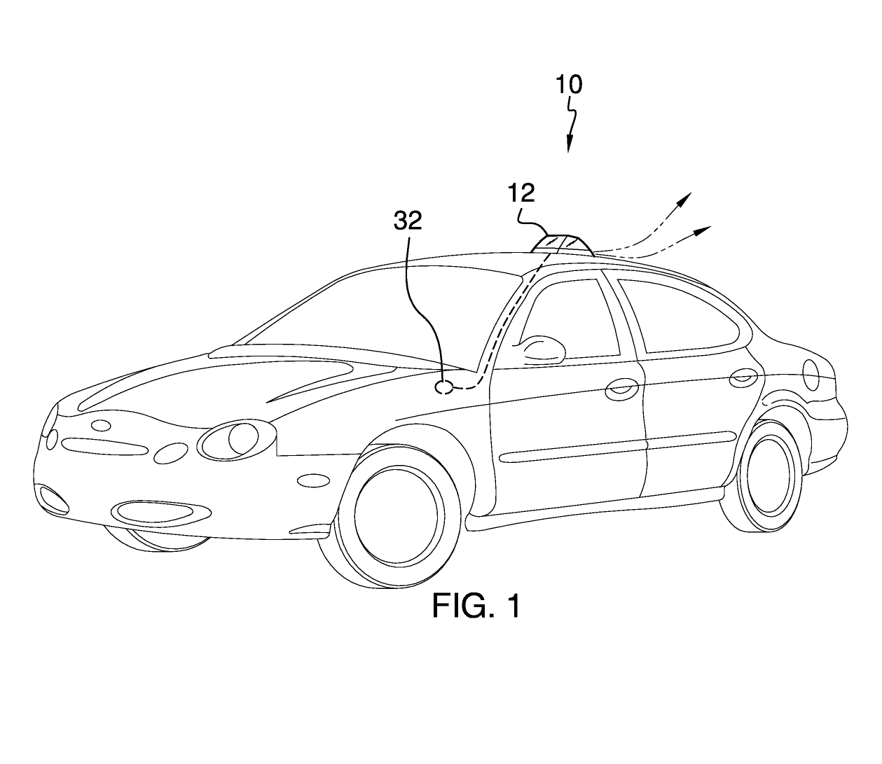

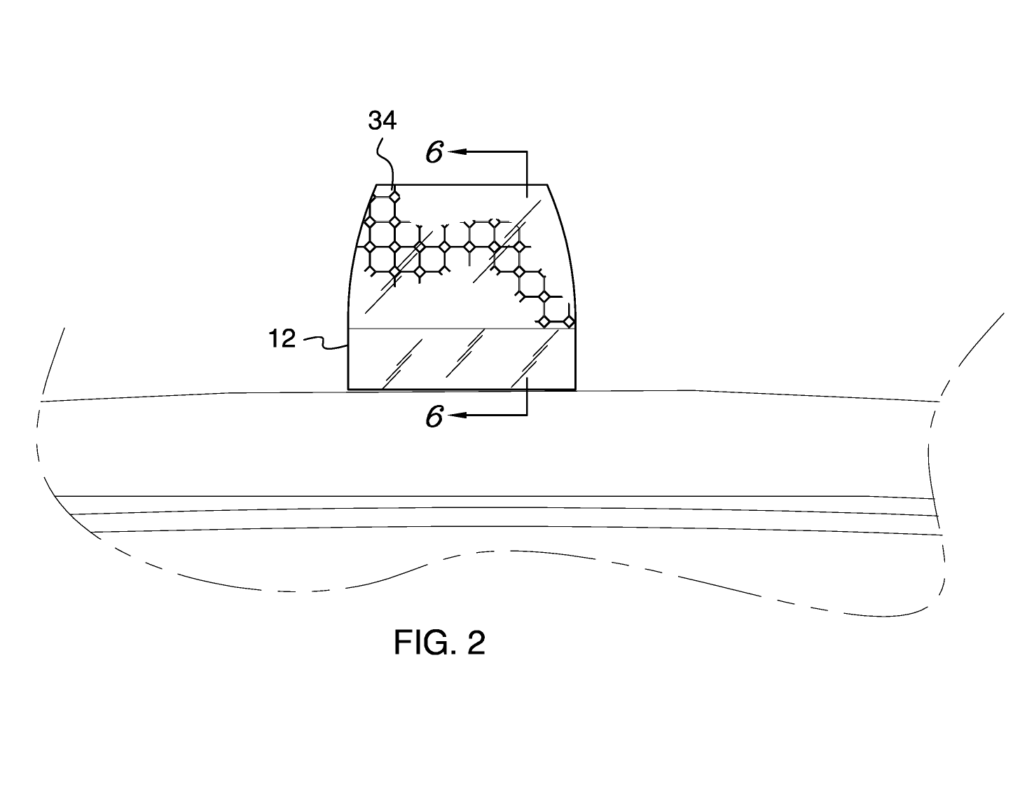

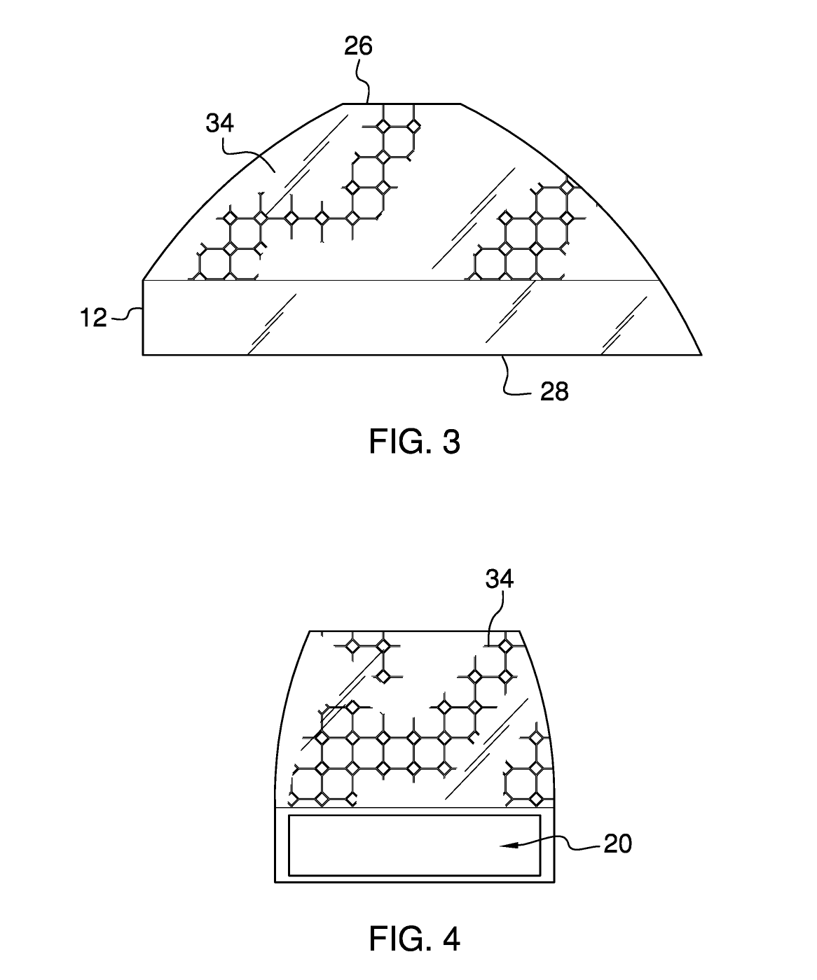

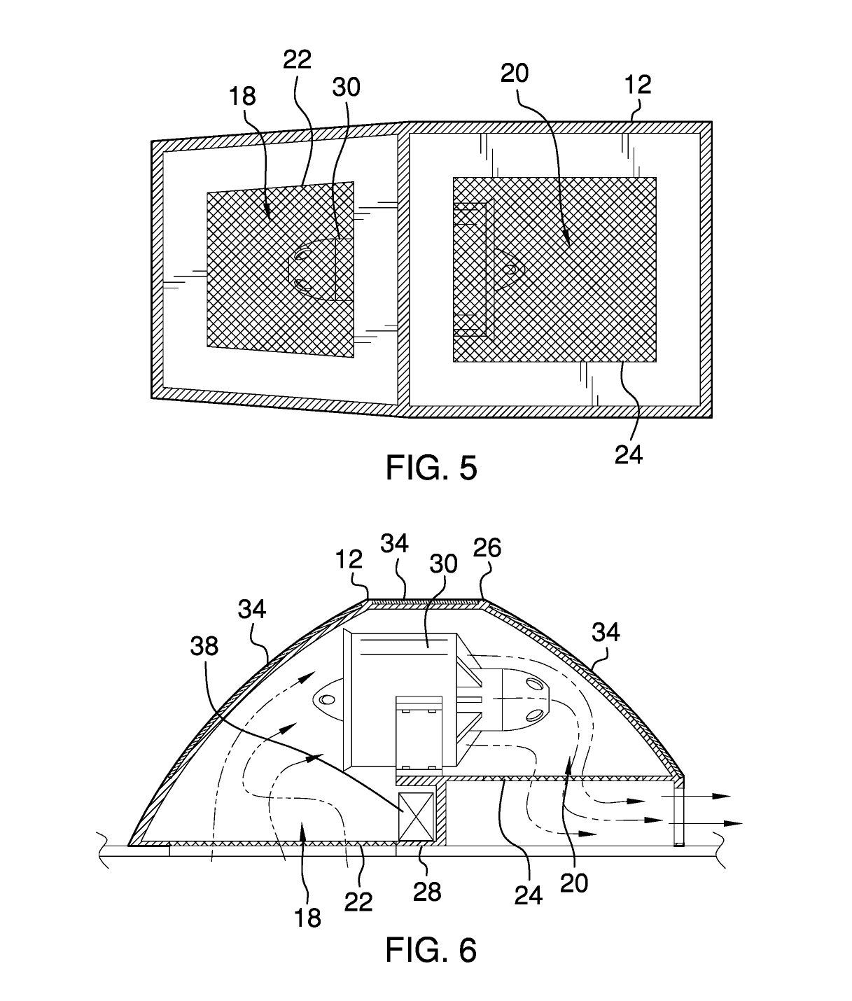

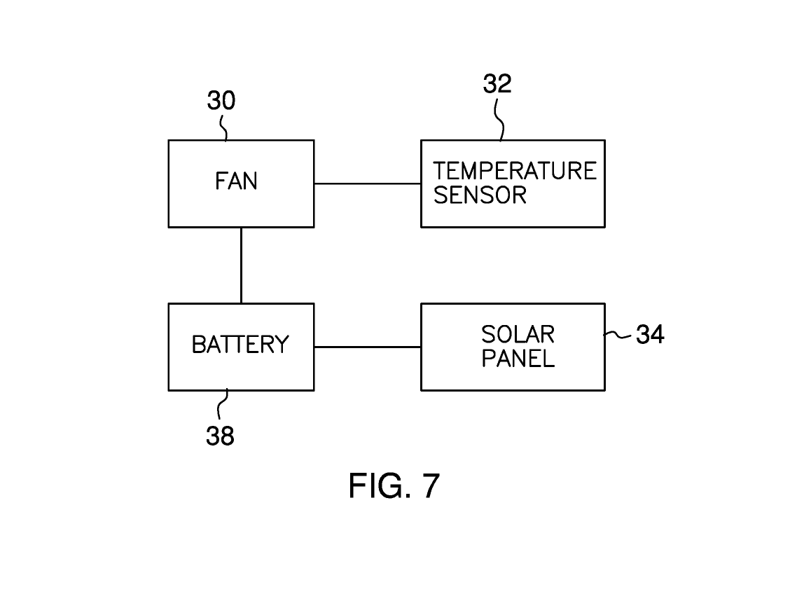

With reference now to the drawings, and in particular to FIGS. 1 through 7 thereof, a new safety device embodying the principles and concepts of an embodiment of the disclosure and generally designated by the reference numeral 10 will be described.

As best illustrated in FIGS. 1 through 7, the vehicle safety assembly 10 generally comprises a housing 12 that may be mounted on a roof 14 of a vehicle 16 and the housing 12 has an intake 18 and an exhaust 20. The intake 18 is in fluid communication with an interior of the vehicle 16 and the exhaust 20 is in fluid communication with the intake 18. A first screen 22 is coupled to the housing 12 and the first screen 22 covers the intake 18 to inhibit objects from passing through the intake 18. A second screen 24 is coupled to the housing 12 and the second screen 24 covers the exhaust 20 to inhibit objects from passing through the exhaust 20. The housing 12 may have a top wall 26 and a bottom wall 28 and the bottom wall 28 may be attached to the roof 14 of the vehicle 16. Additionally, the top wall 26 may be concavely arcuate with respect to the bottom wall 28 such that the housing 12 has a dome shape or other aerodynamic shape.

A fan 30 is positioned within the housing 12 and the fan 30 urges air when the fan 30 is turned on. The fan 30 draws air in through the intake 18 and out through the exhaust 20 to ventilate the interior of the vehicle 16. Thus, the fan 30 reduces a temperature of the interior of the vehicle 16 to inhibit an unattended occupant from being injured by excessive temperatures in the vehicle 16. The vehicle 16 may be a passenger vehicle, a commercial vehicle and any other vehicle with an enclosed cabin. Additionally, the fan 30 may be an electric fan that includes a motor and plurality of blades.

A temperature sensor 32 is provided and the temperature sensor 32 is positioned within the vehicle 16 such that the temperature sensor 32 is in thermal communication with the interior of the vehicle 16. The temperature sensor 32 is electrically coupled to the fan 30 and the temperature sensor 32 turns the fan 30 on when the temperature sensor 32 senses a trigger temperature. The trigger temperature may be any temperature at or above approximately 80.0 degrees Fahrenheit. Additionally, the temperature sensor 32 may be an electronic thermostat of any conventional design.

A solar panel 34 is provided and the solar panel 34 is coupled to the housing 12. The solar panel 34 is positioned on an exterior surface 36 of the housing 12 such that the solar panel 34 is exposed to sunlight. A battery 38 is positioned within the housing 12 and the battery 38 is electrically coupled to the solar panel 34 such that the solar panel 34 charges the battery 38. Moreover, the battery 38 is electrically coupled to the fan 30 and the temperature sensor 32.

In use, the temperature sensor 32 turns the fan 30 on when the temperature sensor 32 senses the trigger temperature in the interior of the vehicle 16. Thus, the fan 30 urges air in the interior of the vehicle 16 outwardly through the exhaust 20 to ventilate the interior of the vehicle 16. In this way the fan 30 lowers the temperature of the interior of the vehicle 16. Additionally, the solar panel 34 and the battery 38 ensure the fan 30 and temperature sensor 32 functions when the vehicle 16 is turned off. Thus, the unattended occupant, such as a child or the like, is protected from a heat injury resulting from excessive temperatures in the vehicle 16.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A vehicle safety assembly being configured to selectively vent an interior of a vehicle thereby inhibiting an occupant from being exposed to excessive temperatures, said assembly comprising:
a housing being configured to be mounted on a roof of a vehicle;
a fan being positioned within said housing wherein said fan is configured to urge air when said fan is turned on, said fan ventilating an interior of the vehicle wherein said fan is configured to reduce a temperature of the interior of the vehicle thereby inhibiting an unattended occupant from being injured by excessive temperatures in the vehicle; and
a temperature sensor being configured to be positioned within the vehicle such that said temperature sensor is in thermal communication with the interior of the vehicle, said temperature sensor being electrically coupled to said fan, said temperature sensor turning said fan on when said temperature sensor senses a trigger temperature.

2. The assembly according to claim 1, wherein said housing has an intake and an exhaust, said intake being configured to be in fluid communication with an interior of the vehicle, said exhaust being in fluid communication with said intake.

3. The assembly according to claim 2, further comprising a first screen being coupled to said housing, said first screen covering said intake wherein said first screen is configured to inhibit objects from passing through said intake.

4. The assembly according to claim 2, further comprising a second screen being coupled to said housing, said second screen covering said exhaust wherein said second screen is configured to inhibit objects from passing through said exhaust.

5. The assembly according to claim 1, further comprising a solar panel being coupled to said housing wherein said solar panel is configured to be exposed to sunlight, said solar panel being positioned on an exterior surface of said housing.

6. The assembly according to claim 5, further comprising a battery being positioned within said housing, said battery being electrically coupled to said solar panel such that said solar panel charges said battery, said battery being electrically coupled to said fan and said temperature sensor.

7. A vehicle safety assembly being configured to selectively vent an interior of a vehicle thereby inhibiting an occupant from being exposed to excessive temperatures, said assembly comprising:
a housing being configured to be mounted on a roof of a vehicle, said housing having an intake and an exhaust, said intake being configured to be in fluid communication with an interior of the vehicle, said exhaust being in fluid communication with said intake;
a first screen being coupled to said housing, said first screen covering said intake wherein said first screen is configured to inhibit objects from passing through said intake;
a second screen being coupled to said housing, said second screen covering said exhaust wherein said second screen is configured to inhibit objects from passing through said exhaust;
a fan being positioned within said housing wherein said fan is configured to urge air when said fan is turned on, said fan drawing air in through said intake and out through said exhaust wherein said fan is configured to ventilate the interior of the vehicle, said fan reducing a temperature of the interior of the vehicle wherein said fan is configured to inhibit an unattended occupant from being injured by excessive temperatures in the vehicle;
a temperature sensor being configured to be positioned within the vehicle such that said temperature sensor is in thermal communication with the interior of the vehicle, said temperature sensor being electrically coupled to said fan, said temperature sensor turning said fan on when said temperature sensor senses a trigger temperature;
a solar panel being coupled to said housing wherein said solar panel is configured to be exposed to sunlight, said solar panel being positioned on an exterior surface of said housing; and
a battery being positioned within said housing, said battery being electrically coupled to said solar panel such that said solar panel charges said battery, said battery being electrically coupled to said fan and said temperature sensor.
